(19) United States
(12) Patent Application Publication
(10) Pub. No.: US 2025/0055173 A1
(43) Pub. Date: Feb. 13, 2025

(54) A COATED AUTOMOTIVE GLAZING WITH INTEGRATED RADAR UNIT

(71) Applicant: SAINT-GOBAIN GLASS FRANCE, COURBEVOIE (FR)

(72) Inventors: Arunvel THANGAMANI, CHENNAI (IN); Robin C JAYARAM, KERALA (IN); Balamurugan TS, PUDUCHERRY (IN); Naveinah CHANDRASEKARAN, CHENNAI (IN)

(21) Appl. No.: 18/721,611

(22) PCT Filed: Dec. 1, 2022
(86) PCT No.: PCT/IN2022/051046

§ 371 Date: Jun. 18, 2024

(30) Foreign Application Priority Data
Dec. 24, 2021 (IN) 202141060587

(51) Int. Cl. H01Q 1/12; B32B 17/06; G01S 13/931

(52) U.S. Cl. CPC H01Q 1/1271; B32B 17/06; G01S 13/931

(57) ABSTRACT

An automotive glazing includes at least a first substrate of glass or polymer, at least one functional layer having electromagnetic properties, a radar unit and one or more antenna units. At least one de-coated region is defined on the at least one functional layer on the glass or polymer substrate. Further, at least a portion of the antenna unit is aligned with de-coated region and the antenna unit is connected to the radar unit.

### TECHNICAL FIELD

The present disclosure relates to display in automotive, specifically, this disclosure relates to an automotive glazing with system capable of radio detection and ranging (RADAR). More specifically, the present disclosure relates to an automotive glazing with functional layers or coating and having RADAR units and plurality of antenna units configured to various automotive based applications.

### BACKGROUND

Background description includes information that may be useful in understanding the present disclosure. It is not an admission that any of the information provided herein is prior art or relevant to the presently claimed disclosure, or that any publication specifically or implicitly referenced is prior art.

It is known to one skilled in the art that glazing refers to any and all the glass or similar material within a structure or the installation of any piece of glass or the similar material within a sash or frame. The glass windows of an automobile are referred to as glazing. For laminated glazing, two or more layers of glass or a similar material, are fused together with an interlayer in the middle. The fusion is completed with pressure and heat and it prevents the sheets of glass or the similar material from breaking. While some pieces of glass or the similar material might end up breaking into larger pieces, those pieces will stay together with the help of the interlayer, making it shatterproof. Further existent in the art are automotive plastic based glazing such as pillar parts of the vehicle.

There are solutions based on LiDar or camera based object detection. However, it is seen that those are affected by presence of fog, dust or rain as the optical properties are significantly compromised in these environments. Radio frequency based units are able to function better in detrimental weather or road conditions due to RF signal transparency. RADAR (or simply radar) is widely used for various automotive applications. Radar system is essentially needed to identify the obstacle and the objects nearby the vehicle in nanoseconds scale of time as the electromagnetic waves travel with speed of light. Radar units employed in a windshield helps in collision avoidance, emergency braking and similarly, in quarterlite, backlite, sidelite, sunroof helps in parking assistance, blind spot detection, track change warning, child detection inside car, seat belt violation and the like. The Radar unit may be embedded in the glazing, however, if there are functional coating on the glazing, it is usually a challenge to overcome the electromagnetic interferences.

Reference is made to U.S. Pat. No. 9,878,597B2 that discloses a pane with high-frequency transmission. The therein disclosed panel has an outer face and an inner face, at least one transparent, electrically-conductive coating, which is arranged on the outer face and/or on the inner face of the first panel, and at least one region having at least one outer de-coated structure and one inner de-coated structure, the transparent, electrically-conductive coating being located between the outer de-coated structure and the inner de-coated structure and inside the inner de-coated structure.

Reference is made to WO2005/011052 that discloses a pane with an electrically conducting and heatable coating and at least one communication window. The therein disclosed solution relates to a substrate for a window comprising an electroconductive heatable coating, at least one communication window \ which is arranged therein in the form of the interruption of said coating and enables communication radiation to pass therethrough in the form of an information-carrier signal whose wavelength ranges within a range of wavelengths reflectable or absorbable by the coating and another electroconductive element contactable with at least one part of the window edge and with the coating. The invention is characterised in that said communication window is provided with an electroconductive covering and electrically connected thereto.

Reference is made to IN202141059686 that discloses an automotive glazing for inclusion of antenna unit and radar unit within the glazing. However, the disclosure is directed at non-coated glazing and, the antenna units embedded therein are not formed out of any functional layer coating, but may be embedded or integrated on the glazing as patch or may be printed.

In view of the existing solution, it is seen that radar antenna in coated glazing has radio frequency (RF) communication issues in coated glazing of an automotive. The conventional solutions include making a cut-out on the coating to allow RF signal transmission, or use glass or interlayer as a dielectric layer. Patterning of the coating may be performed to create less interference in the RF signal, but this would be dependent on multiple factors inclusive of the desired design and end-application. Effective utilization of these modifications on the coating to incorporate antenna units such as that of radar antenna onto the glazing involves challenges. Additionally, most radar units are fabricated on a hard printed circuit board or chip which are thicker and space is a constraint in automotive glazing. In the view of the problems of the prior art solutions, herein is proposed an automotive glazing that effectively utilizes the modifications in the coating to incorporate radar antennas onto the glazing. The solution rendered is also directed at having a thin antenna layer instead of thick radar units.

### SUMMARY OF THE DISCLOSURE

An object of the present invention is to provide a coated automotive glazing with radar unit overcoming the drawbacks of the prior art.

Another object of the present invention is to provide a coated automotive glazing with radar unit and respective antenna units.

Still further object of the present invention is to provide a coated automotive glazing in which the design on the coating layer, by way of selective etching provides antenna communication units.

These and other objects of the invention are achieved by the following aspects of the invention. The following disclosure presents a simplified summary of the invention in order to provide a basic understanding of some aspects of the invention. This presents some concept of the invention in a simplified form to a more detailed description of the invention presented later. It is a comprehensive summary of the disclosure and it is not an extensive overview of the present invention. The intend of this summary is to provide a fundamental understanding of some of the aspects of the present invention.

In an aspect of the present invention is disclosed an automotive glazing with integrated radar unit, in which the automotive glazing is coated. The automotive glazing comprises at least a first substrate of glass or polymer; at least one functional layer having electromagnetic properties; a radar unit partially or completely disposed in the glazing and one or more antenna units disposed on said substrate of the glazing. The glazing comprises one or more de-coated structures on the at least one functional layer on said glass or polymer substrate configured to function as antenna units, in which the at least one radar unit is configured to communicate with said one or more antenna units and function with minimum signal loss.

In another aspect of the present invention is disclosed a system for radio detection and ranging (radar) in a vehicle. The system comprises at least a first substrate of glass or polymer, at least one functional layer having electromagnetic properties, a radar unit partially or completely disposed within the glazing, one or more antenna units disposed on said substrate of the glazing. The glazing comprises one or more de-coated structures on the at least one functional layer on said glass or polymer substrate configured to function as antenna units. The at least one radar unit is configured to communicate with said one or more antenna units. The system further includes a control unit located outside the glazing, operably coupled with the radar unit and the one or more antenna units for detection of objects for at least being applied for blind spot detection, forward and rear collision, parking assistance, lane change and adaptive cruise control, wherein the location of said one or more antenna units in the glazing is dependent on one of said applications.

The disclosed invention provides an automotive glazing capable of effectively utilizing the modifications on a functional layer to incorporate radar antennas onto the glazing. The modifications or customizations brought forth are mostly in the antenna layer i.e. dimensions, material electrical properties and the like to match with needs of the radar unit. The present invention focuses on using of an existing conductive coating to provide both the transmission of radio frequency signals and use the design structure of the coating to enable antenna functions.

The significant features of the present invention and the advantages of the same will be apparent to a person skilled in the art from the detailed description that follows in conjunction with the annexed drawings.

### BRIEF DESCRIPTION OF THE ACCOMPANYING DRAWINGS

The following briefly describes the accompanying drawings, illustrating the technical solution of the embodiments of the present invention or the prior art, for assisting the understanding of a person skilled in the art to comprehend the invention. It would be apparent that the accompanying drawings in the following description merely show some embodiments of the present invention, and persons skilled in the art can derive other drawings from the accompanying drawings without deviating from the scope of the disclosure.

FIG. 1A illustrates an exploded view of an automotive glazing 100, in accordance with an embodiment;

FIG. 1B illustrates a cross-sectional view of an automotive glazing 100, in accordance with an embodiment;

FIG. 2A illustrates an exploded view of an automotive glazing 200 with an interlayer, in accordance with an embodiment;

FIG. 2B illustrates a cross-sectional view of an automotive glazing 200 with an interlayer, in accordance with an embodiment;

FIG. 3 illustrates a schematic of an antenna radiation lobe in a conventional laminated glazing 300 without a functional layer;

FIG. 4 illustrates a schematic of an antenna radiation lobe in a coated glazing, in accordance with an embodiment;

FIG. 5 illustrates a schematic of an antenna radiation lobe in a coated glazing, in accordance with an embodiment;

FIG. 6 illustrates an exploded view of an automotive glazing 600, in accordance with an embodiment;

FIG. 7 illustrates an exploded view of an automotive glazing 700, in accordance with an embodiment;

FIG. 8 illustrates an exploded view of an automotive glazing 800 with an interlayer, in accordance with an embodiment;

FIG. 9 illustrates a schematic of a pattern of functional layer, in accordance with an embodiment;

FIG. 10 illustrates an automotive glazing with a patterned functional layer, in accordance with an embodiment;

FIG. 11 illustrates an automotive glazing with a teeth-like patterned functional layer, in accordance with an embodiment;

FIG. 12 illustrates an automotive glazing with a graph-like patterned functional layer, in accordance with an embodiment;

FIG. 13 illustrates a cross-sectional view of an automotive glazing, in accordance with an embodiment;

Persons skilled in the art will appreciate that elements in the figures are illustrated for simplicity and clarity and have not necessarily been drawn to scale. For example, the dimensions of some of the elements in the figures may be exaggerated relative to other elements to help to improve understanding of embodiments of the disclosure.

### DETAILED DESCRIPTION

The present disclosure is now discussed in more detail referring to the drawings that accompany the present application. It would be appreciated by a skilled person that this description to assist the understanding of the invention but these are to be regarded as merely exemplary.

The terms and words used in the following description are not limited to the bibliographical meanings and the same are used to enable a clear and consistent understanding of the invention. Accordingly, the terms/phrases are to be read in the context of the disclosure and not in isolation. Additionally, descriptions of well-known functions and constructions are omitted for clarity and conciseness.

Automotive radars in general are used to detect the speed and range of objects in the vicinity of the car. An automotive radar consists of at least a transmitter and a receiver. The various embodiments of the present invention are directed at an automotive glazing having an integrated radio frequency detection and ranging system with a radar unit within the glazing and further having one or more antenna units configured to enable different applications. Generally, a radar unit or system may comprise a transmitter which is powered by amplifier signals that are generated here using a waveform generator, multiple waveguides capable of facilitating transmission of radar signals, antenna configured to transfer the transmitter energy to signals in space, a receiver capable of being used for detection and capture of signals, and a processing unit which uses captured signals and their properties to derive detection, ranging and other useful information. In an exemplary implementation of the present invention, said radar unit may be a radar on chip and may comprise a receiver, a transmitter, a transceiver, scanner/antenna, an indicator, and the like. Said radar unit is adapted to be embedded in a cut-out of the substrate of the glazing. The integration of radar on chip in glazing is a challenge given the thickness restriction of the substrates of the glazing. Further, in an embodiment of the present invention is included multiple antenna being disposed all across the vehicle for enabling better coverage and facilitating the working of the same in tandem for multiple applications. Furthermore, in a vehicle, multiple radar units may be integrated in one or more glazing of the vehicle and the same may be connected to a control unit for enabling specific applications. In an implementation of the present invention, there may be an intermediate data acquisition unit or a DAQ for collecting the data from the various radar units. The one or more radar units may be configured to a control unit directly or via the DAQ to the control unit. The control unit may be the electronic control unit of the vehicle (ECU).

The present invention is directed at an automotive glazing with a radar system. In said automotive glazing is included a functional layer such as a functional coating. The coating may be capable of infra-red radiation reflection (IRR), or any other value added coatings or modifications of glazing such as that of metallic coating or ceramic coating or polymeric layer. The coating may be transparent or non-transparent. Said radar system includes a radar unit for radio ranging and detection and one or more antenna units operably coupled with said radar unit. In an implementation of the present invention, the radar unit may be a radar on chip. It may comprise a receiver, a transmitter, a transceiver, scanner/antenna, an indicator, and the like. The radar unit may be composed of semiconductor chip for transmitting and receiving radio waves. Said chip may be a CMOS (Complementary Metal-Oxide-Semiconductor) integrated circuit (IC) and may include radio frequency integrated chip. The present invention further includes customizing the design of the antenna for being in alignment with the glazing. Further provided is an integration methodology for the radar unit using the existing coating layer on glazing as part of the radar antenna. The antenna designs are customized considering the electrical properties and dimensions of the different substrates of the glazing and is customized to ensure minimal signal loss when communicating through the glass and the interlayers. The radar system may be further communicatively coupled to a control unit (such as and not limited to electronic control unit of the vehicle) for various applications such as for blind spot detection, forward and rear collision, parking assistance, lane change and adaptive cruise control, wherein the location of said one or more antenna units in the glazing is dependent on one of said applications.

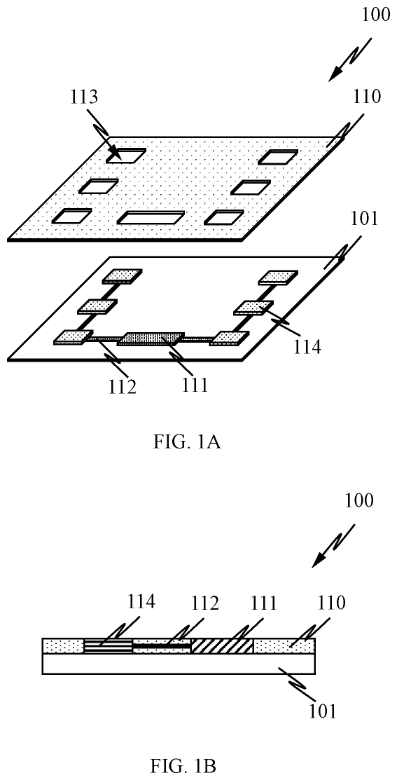

Reference is made to FIGS. 1A-1B, the automotive glazing (100) may comprise a first substrate 101 of glass or polymer, at least one functional layer (110) having electromagnetic properties, at least one antenna unit 114 and a radar unit 111 connected to the antenna unit 114. Further, at least one de-coated region 113 may be defined on the functional layer 110. The antenna unit 114 may be disposed on the first substrate 101 and positioned in a manner that at least a portion of the antenna unit 114 is aligned with the de-coated region 113. The de-coated region 113 acts as a window for the RF waves to pass through the glazing 100 towards and from the antenna unit 114. Such a configuration enables the transmission of the RF signals with minimum signal loss.

Each of the antenna units 114 may be connected with each other via connection lines 112 disposed on the first substrate 101 of the glazing 100. Further, the radar unit 111 may be disposed on the first substrate 101.

In one embodiment, the radar unit 111 may be a Radar-on-Chip unit disposed on the first substrate 101 of the glazing 100.

In one embodiment, the functional layer 110 may be a coating such as IRR coating.

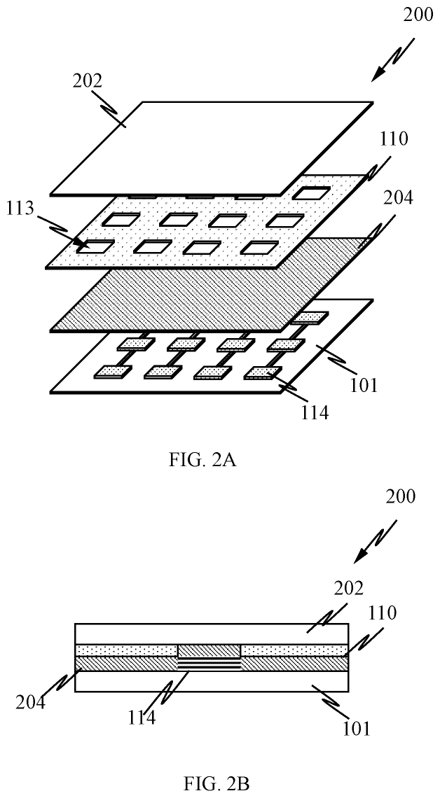

FIGS. 2A-2B illustrates an automotive glazing 200 with an interlayer 204, in accordance with an embodiment. The glazing 200 may comprise a first substrate 101, at least one interlayer 204, a functional layer 110, a second substrate 202, at least one antenna unit 114 and a radar unit 111 (not shown) connected to the antenna unit 114. The antenna unit 114 and the radar unit 111 may be disposed on the first substrate 101 and further the interlayer 204 may be stacked over the first substrate 101. The functional layer 101 may be coated over the interlayer 204 and finally the second substrate 202 is the disposed over the functional layer 110 such that the interlayer 204 is sandwiched between the first substrate 101 and the second substrate 202.

Further, at least one de-coated region 113 is defined on the functional layer 110 such that at least a portion of the antenna unit 114 is aligned with the de-coated region 113.

In one embodiment, the de-coated regions 113 are selectively designed/patterned and positioned across the glazing (100, 200) based on the requirement.

In an implementation of the present invention, de-coated regions 113 may be obtained by fully coating the first substrate 101 of the glazing with a coating to form a functional layer 110. Further, the coating is selectively removed in accordance with the requirements.

In one embodiment, the de-coated regions 113 may be formed by selectively etching the portions on the functional layer 110. The etching may be performed by laser, abrasion, chemical etching or the like. Other surface material removal methods, such as surface grinding, may also be used for obtaining the de-coated regions 113 in the functional layer 110.

Alternatively, the de-coated regions 113 may be obtained by creating masks on the first substrate 101 and then coating the first substrate 101. It would be appreciated by one skilled in the art that the means of obtaining de-coated regions as mentioned are provided by way of examples and is not limited these.

In an implementation of the present invention the radar unit 111 may not be integrated to the glazing. It may be arranged externally with the one or more antenna unit 114 arranged across the glazing. The one or more antenna units 114 may be a combination of multiple antenna elements 114 dispersed across one or more substrates with one of the elements being satisfied by the coating of the functional layer 110.

In one implementation of the present invention, the radar unit (111) may be disposed via a through-hole or cut-out on the glazing such that the cut-out region extends to one or all the substrates of the glazing, in which said radar unit 111 is in the glazing.

In another embodiment, the radar unit (111) may be mounted on one of the substrates of the glazing by way of surface mounting on one of the substrates of the glazing.

In one embodiment, the antenna units 114 may be configured as a single layer or as multiple layers. In an implementation, the antenna unit 114 may be disposed as one conductive layer on a substrate or a combined effect of two or more conductive layers disposed across one or more substrates of the glazing. For instance, the antenna unit 114 may comprise of an antenna layer which is a conductive layer for transmission or reception, then a di-electric substrate and then a ground plane which is also a conductive layer.

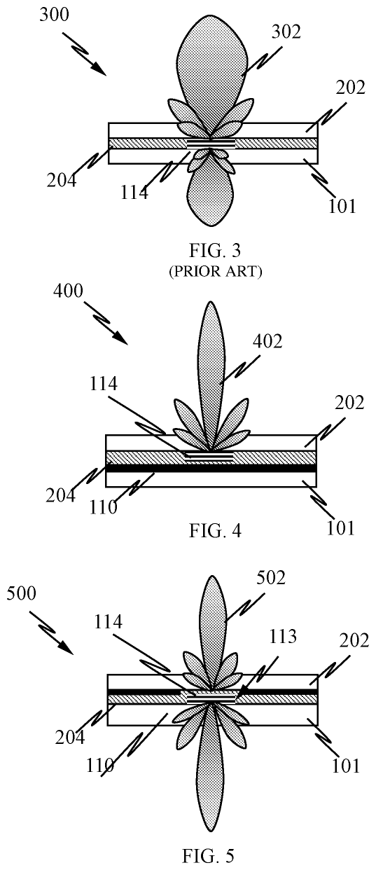

FIG. 3 illustrates a schematic of an antenna radiation lobe in a conventional laminated glazing 300 without a functional layer. The glazing comprises an antenna unit 114 embedded within the laminated glazing without coating.

FIG. 4 illustrates a schematic of an antenna radiation lobe in a coated glazing 400, in accordance with an embodiment. The functional layer 110 (coating) is completely formed on the first substrate 101.

FIG. 5 illustrates a schematic of an antenna radiation lobe in a coated glazing 500, in accordance with an embodiment. The functional layer 110 (coating) is formed on the first substrate 101 with de-coated regions for enabling bidirectional antenna communication. The functional layer 110 may be a metallic IRR coating.

In the coated glazing, the antenna unit 114 may also be integrated on a different layer than the IRR coating layer.

FIGS. 3-5 clearly illustrate the differences in the antenna radiation lobes in uncoated glazing, completely coated glazing and coated glazing with de-coated regions. Such designs thus allow for controlled antenna radiation with the main lobes transmitting perpendicular to the surface of the antenna in the glazing. The metal coating may effectively form as part of the antenna design to act as an emitter, director or reflector or a combination thereof.

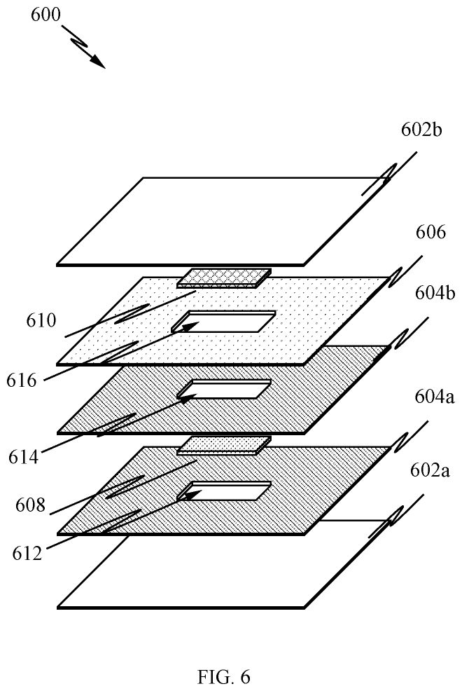

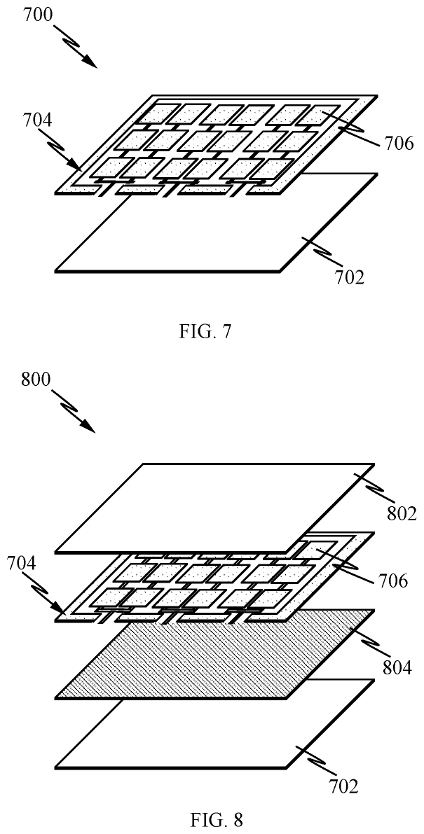

FIG. 6 illustrates an exploded view of an automotive glazing 600, in accordance with an embodiment. In the glazing is provided a means for compensating lost thermal comfort in the cut-out region of the coating. One of the main disadvantage of making cut-out in coating layer is the reduction in thermal comfort and the look and feel/visibility of the cut-out. This may be eliminated by adding another coating which will not affect the signal just in the cut-out region. The glazing 600 may comprise a first substrate 602a, a second substrate 602b, a first interlayer 604a with a first cut-out 612, a second interlayer 604b with a second cut-out 614, an antenna unit 608, a functional layer 606 with a de-coated region 616 and an emissive layer 610. The emissive layer 610 (such as and not limited to UV/IR/Visible) may be positioned in the de-coated region 606 of the functional layer. The emissive layer may be selected so as to match the tint of the functional (coating) layer. Additionally, it may be used for display. In an implementation, for displaying radar information, the data from radar may be fed to a projector which may control what alert icon must be projected in the emissive layer. The emissive layer may be just behind the functional layer. Alternatively, there may be provided the de-coated regions (or openings in coating) filled with a material which can act as IRR or display element. These could be a costly solution when used for the full glass area but beneficial for specific local sizes on the glass. In an implementation of the present invention, the ultra-clear solar film may be partially added (or similar such alternate film) just in the de-coated region so there is no need to compensate on the thermal performance. The ultra-clear film is generally very expensive and adding the same only in the cut out portion gives both functional and economic benefit. The radio frequency meta-surface or meta-material may be used to design antenna in addition to common antenna material like silver, copper, aluminium, CB, CNT or graphene. RF meta-surfaces are designed by means of laser etching as discussed in the phased array concept.

FIG. 7 illustrates an exploded view of an automotive glazing 700, in accordance with an embodiment. The glazing 700 may comprise a first substrate 702, at least one functional layer 704 and a radar unit (not shown). Further, at least a portion of the functional layer 704 is defined as an antenna unit 706 and the antenna unit 706 is connected with the radar unit. In this implementation, the functional layer 704 (coating) is configured to act as an antenna for transmitting and receiving signals thereby eliminating the requirement for a separate antenna.

FIG. 8 illustrates an exploded view of an automotive glazing 800 with an interlayer 804, in accordance with an embodiment. The glazing 800 may comprise a first substrate 702, a second substrate 802, at least one interlayer 804 sandwiched between the first substrate 702 and the second substrate 802, a functional layer 704 and a radar unit (not shown). Further, at least a portion of the functional layer 704 is defined as an antenna unit 706 and the antenna unit 706 is connected with the radar unit.

In an embodiment of the present invention, the functional layer 704 (coating) may be patterned to act as antenna elements. In an embodiment, the coating can then be patterned in mostly C zones or sun visor regions by selective removal or coating of the functional or IRR layers to create openings for RF transmission. The functional layer 704 may be designed as per the requirements and transferred to the coating by way of laser etching, abrasive, coating while masking or similar processes, however, not limited to this. The entire area of the sun visor may be used for creating large area antenna or arrays. The patterns may also act as individual antenna, thereby by the design of the antenna may be controlled by adding or subtracting the number of elements so as to achieve the different RF frequency ranges and communication distances.

In an implementation of the present invention, the antenna design is dependent on the frequency range of operation. The antenna unit may be completely made of the coating (such as infrared radiation reflective, IRR, coating) or partially along with another antenna element printed or integrated to the substrate of the glazing. Generally, an automotive radar works on above 10 GHZ ranges and commonly used frequencies are 24 GHz and 77 GHz bands. The coverage distance of detection and ranging by one such radar may be in any of the categories of short range radar (SRR) encompassing 0.5 to 20 meters, medium range radar (MRR) encompassing 1 to 60 meters and long range radar (LRR) encompass 10 to 250 meters. It would be appreciated by one skilled in the art that the ranges distance meant for radar ranging is not strictly limited to said ranges and may be application specific as well.

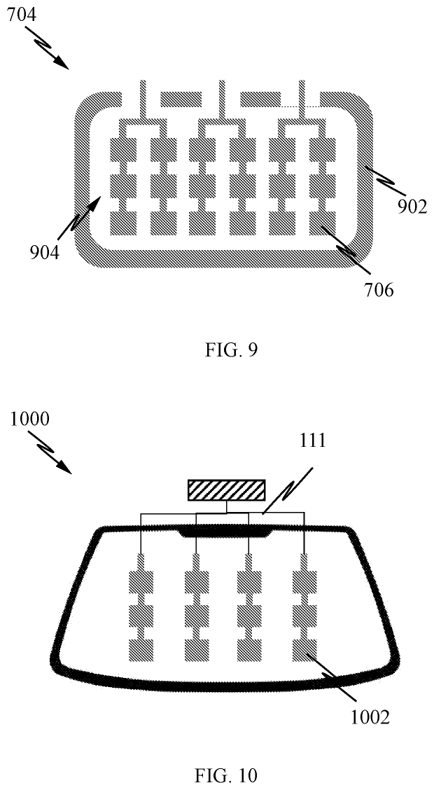

FIG. 9 illustrates a schematic of a pattern of functional layer 704, in accordance with an embodiment. In an embodiment of the present invention, the antenna unit 706 and the functional layer 704 may be selectively designed. Based on the design, the number of antenna structures are fixed and the same is located on the coated glazing. To supplement the understanding of a skilled person, an example is considered where the radar antenna units for object detection may be designed to be located in the centre of a windshield and a backlite of the vehicle with 2 transmitter antennas sending the signal and 5 receiving antennas configured to receive the signal. An instance of a design for this example may be the patterned coating with antenna units or elements connected together for achieving an antenna performance for a 77 GHz frequency radar application, such as that shown in FIG. 9.

For determining the design, the antenna size may be required. The antenna size is dependent on the wavelength (λ) of the communication wave, which is 4 mm. The antenna size is given by λ/4 which is 1 mm. In an implementation, for a phased array element, the pitch distance may be given as λ/2 which is 2 mm. Upon computation of said parameters, the design may be optimized based on the minimum gap needed for the array antenna to work and provide the relevant radio frequency (RF) transmission. The antenna design may be optimized for RF transmission for frequencies such as and not limited to 5G, Wireless Fidelity (WiFi), ultra-high frequency (UHF), long term evolution (LTE), global positioning system (GPS) and the like which is decided depending upon the application. In an exemplary embodiment of the invention, for GPS transmission for a mobile device inside vehicle, the de-coating or the cut-out 904 in of the coating should be greater than λGPS/4 which is 47.5 mm. This may be achieved by a continuous open line 902 around the circumference of the radar region. Advantageously, the de-coating of the functional layer for creating the antenna patterns may be effectively used as a RF transmission design. The antenna designs or patterns formed by the designs or patterns of the de-coated structure includes any of thin line graph like structures, graph or grid like, teeth-like structures, meta-surface patterns, or dedicated communication window with radar antenna array integrated to said window or openings or a combination of any of these. Designs or patterns formed on conductive infrared reflective coating have optimized openings and cut-outs, making it suitable for rendering thermal comfort as well. The coated/infrared reflective part of the formed design may be capable of functioning as a defogger unit and due to the presence of more metallic thermally conductive layer, the heating discontinuity may be reduced as compared to a completely open communication window.

In an implementation of the present invention, the number of transmitter and receiver antennas may be selected based on the application or the use case. For instance, there may be two transmitter antennas and five receiver antennas for lane change or traffic manoeuvring. For object detection, one may have one transmitter and once receiver antenna. The customizations are mostly in the antenna layer i.e. dimensions, material electrical properties and the like to match with needs of the radar.

This further result in low production cost of production since the same coating is used for different functions. Additionally, the expenses involved in removal of material of the coating is lower compared to that of having a communication window design on the coating. In an implementation of the present invention, the usage of a dedicated communication window adapted to be place the antenna's functional layers is useful for effective utilization of the open cut-out. This layer may be selected to provide the infrared protective function similar to existing coating. Furthermore, there may be an antenna structure having a combination of IRR coating based antenna and another antenna embedded which may be included printing or patch integration (for instance). This can facilitate efficient utilization of space.

In an implementation of the present invention, the radar unit such as a radar on chip unit is integrated to the coated glazing. The coating may be provided on one of the glazing layers of the automotive and is adapted for providing the thermal comfort inside a vehicle cabin. The Radar antenna is designed such that the coating becomes part of the antenna structure. In an implementation of the present invention, the di-electric or insulating layer between an antenna signal layer and a ground plane layer may be configured by the IRR coating (or the metal coating). In an instance of this implementation, the interlayer may be used as the di-electric or insulating layer, while in another instance the interlayer and the glass substrate may be used as the di-electric or insulating layer for the antenna structure or unit. In an embodiment of the present invention, antenna design may be provided for a coated glazing without modifying the existing coating layer.

The means to increase or decrease the beam width of the antenna is dependent on the design of the antenna. In an implementation, the coating layer may be used a ground plane. In an instance, for infinite ground plane, the size of the ground plane need to be far greater than λ/2, where λ is wavelength of the radar signal. Ground plane is common in antenna structures. However, a glazing, an antenna size or the RF signal wavelength (λ) are some of the deciding factor of antenna design. For using the IRR coating as a directional or reflector layer, the antenna may be placed on one side of the interlayer (such as a PVB layer) and the IRR coating on the other side for creating a directional antenna. Generally, directional antenna has higher gain in a particular direction than an omni-directional case or from an isotropic antenna. The gain is 1 in case of isotropic antenna. With respect to a directional antenna, the beam width achieved by antenna design affects the Gain. Accordingly, a hemispherical beam width results in 3 dB gain. This continues to increase with constricted and narrower beam widths. Gain, G of an antenna hence may be defined by the following:

$$Gain , G = \frac{4 π A η}{{λ}^{2}}$$

in which A is an effective antenna aperture area, λ is wavelength of the signal and η is efficiency.

Accordingly, in an implementation of the present invention is provided usage of reflectors in the antenna, which advantageously reduces the beam forming area by half. In ideal condition, this could be achieved by creating a constructive waveform as of the original radar waveform i.e. in-phase or minimal phase difference. This requires the reflector to be placed at λ/4 for a preferred scenario since it advantageously results in doubling of the radar power. From radar theory,

$$Radar range , R = \frac{{P}_{t} * G * S * A}{{( 4 π )}^{2} * {P}_{min}}$$

in which,
Pₜ is transmitted Peak power

### G is Gain

A is Antenna aperture area
S is radar cross section, and
Pₘᵢₙ is minimum detectable signal

Considering all the other parameters constant, it may be confirmed that, radar range R is directly proportional to gain, G.

Such a configuration where the coating layer is configured to act as antenna has inherent benefits. By having a patterned configuration of coating layer, about 95-98% of the glazing is covered by the coating while the coating also functions as antenna. Therefore, such a configuration enables to maintain the thermal comfort similar to a fully coated glazing.

FIG. 10 illustrates an automotive glazing 1000 with a patterned functional layer, in accordance with an embodiment. Referring to FIG. 10, antenna designs 1002 may be patterned or etched to pattern of desired application, square patches of coatings are created by etching in a square pattern. The individual patch sizes may be designed to match the antenna for a particular radar frequency. The square patterns may be regular, staggered, of varying sizes or partially removed. In an implementation of the present invention, the antenna designs may be even non-square or rectangular in shape and are custom designed to match the use case of the antenna based on the location. For instance, an LRR antenna may be provided in the bottom of a windshield or backlite with SRR antenna near the top edge of the glazing.

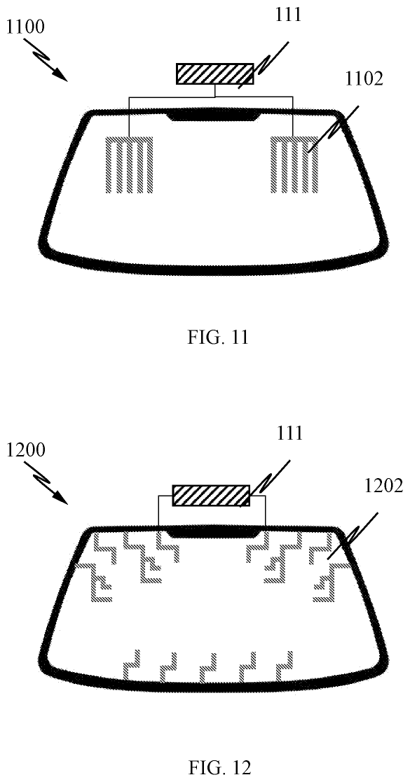

FIG. 11 illustrates an automotive glazing 1100 with a teeth-like patterned functional layer 1102, in accordance with an embodiment. Referring to FIG. 11, the antenna structure is provided as a thin line based design in the communication window region similar to a comb or teeth-like structure 1102. The teeth-like structures are grouped together or electively cut to provide required antenna design features. The design features may be based on the use cases or are dependent on position of the antenna and is similar to selection of number if transmission and receiving antennas as explained earlier. In an implementation of the present invention, the coating layer is configured to function as the antenna element, specifically emitter. The design customizations may be brought for by ways changes in material dielectric property—i.e. for any of the antenna layers, the dimensions and thickness of the layer, and the position in the glazing assembly etc.

FIG. 12 illustrates an automotive glazing 1200 with a graph-like patterned functional layer 1202, in accordance with an embodiment. Referring to FIG. 12, the coating can be patterned like a graph paper design 1202. The dimensions of such designs are dependent on the frequency or wavelength and the number of transmitter-receiver needed. In an exemplary embodiment of the present invention, is disclosed a possible structure for low cost manufacturing, in which the design palette remains same for all glasses. Post coating the areas are selectively ground or evaporated (laser) off to achieve the final antenna structure. The process is similar for the square grid design also. In grid like structure, the number of squares may be fixed but the active ones are decided and the connection-disconnection is based on the same. The element lengths or pattern shape may be selectively cut or etched based on the requirement. The patterns may be created in the sun visor region and near black ceramic paint regions where the vision of the driver is not affected.

In an implementation of the present invention, the antenna or the circuit elements may be spread across the glazing having laminated or single substrate structure. The grouping of the antenna elements may then be done for reducing number of connector cables across the lamination. Segregation of the antenna elements may be needed to power specific antenna sets depending on application. A combination of transmitter and receiver antennas across the glazing may be achieved to get a stereoscopic effect like a camera.

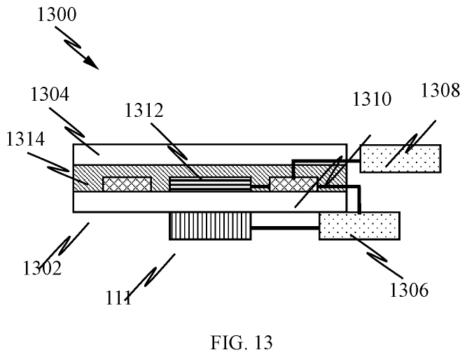

FIG. 13 illustrates a cross-sectional view of an automotive glazing 1300, in accordance with an embodiment. The glazing may comprise a first substrate 1302, a functional layer, an interlayer 1314, a heat grid 1310, a radar unit 111, a power unit 1308, an electrical/thermal isolation unit 1306 and a second substrate 1304. An antenna unit 1312 is defined on the functional layer and further the antenna unit 1312 is connected to the heat grid 1310. The functional layer is configured to enable both antenna transmission and heating of the glazing. When the heat grid is powered ON, the electrical/thermal isolation unit 1306 isolates the radar unit 111 from the antenna 1312 such that the antenna acts as a heater along with the heat grid. This configuration enables better heating of the glazing compared to the glazing with heat grids only.

In an embodiment of the present invention is disclosed a system for radio detection and ranging (radar) in a vehicle. The system comprises at least a first substrate of glass or polymer (101), at least one functional layer (110) having electromagnetic properties, a radar unit (111) partially or completely disposed within the glazing, one or more antenna units disposed on said substrate (101) of the glazing. The glazing further comprises one or more de-coated structures (113) on the at least one functional layer (110) on said glass or polymer substrate (101) configured to function as antenna units, wherein the at least one radar unit is configured to communicate with said one or more antenna units. The system further includes a control unit located outside the glazing. The control unit is operably coupled with the radar unit (111) and the one or more antenna units for detection of objects for a number of application such as and not limited to blind spot detection, forward and rear collision, parking assistance, lane change and adaptive cruise control, wherein the location of said one or more antenna units in the glazing is dependent on one of said applications. In the system, the radar units are configured to a single data acquisition unit. The radar unit along with the one or more antenna units are capable of operating in short, medium and long range frequencies and the design of the de-coated structure is configured to provide the relevant radio frequency transmission for other frequencies including 5G, Wireless Fidelity (WiFi), ultrahigh frequency (UHF), Long-Term Evolution (LTE), global positioning system (GPS).

Radar system in automotive finds varied applications. The radar communication may be useful for detecting the velocity of object. Velocity is determined through chirp frame and there needs to be multiple transmitted antenna that are equally spaced. For radar communication being used for multiple object detection, multiple tones may be differentiated with Fourier transform, with a specific range resolution and bandwidth. Radar communication may be used for angular measurement, and angle calculation to identify the angular positioning of the detected object. In an implementation of the present invention, this may be by way of using two receiving antennas and calculating the phase change through change in small distance. The radar unit embedded in the glazing may be a multiple-input multiple-output (MIMO) radar configured to communicate with an array of transmitting antennas and receiving antennas. There may be applications having dual antenna features in which antenna units may be provided on either side for internal and external sensing (of a vehicle) with an intermediate radar unit. The radar unit integrated within the glazing finds various application such as for adaptive cruise control, autonomous emergency brake, blind spot detection, cascaded imaging radar, front/rear cross-traffic-functions, lane change assistance, parking assistance, radar 360° perception and also reverse-autonomous emergency braking.

Some of the non-limiting advantages of the present invention may be enlisted as:
The de-coating for creating the antenna patterns can be effectively used as a RF transmission design
The openings or cut-outs created are optimized making them negligible effect on thermal comfort as well.
The coated/IRR part can function as defogger unit and due to the presence of more metallic thermally conductive layer the heating discontinuity can be reduced as compared to a completely open communication window.
Low production cost as same coating is used for different functions and also removal of material is reduced compared to a communication window design.
Using a dedicated communication window to place the antenna's functional layer helps with effective utilization of the open cut-out. This layer can be selected to provide the IR protective function similar to existing coating. Also, the combination of IRR coating based antenna and another antenna embedded by printing or patch integration can enable efficient space utilization.

### LIST OF REFERENCE NUMERALS AND FEATURES

100, 200, 300, 400, 500, 600, 700, 800, 1000, 1000, 1100, 1200, 1300: glazing
101, 602a, 702, 1302: first substrate of glass or polymer
202, 602b, 802, 1304: second substrate of glass or polymer
204, 604, 804: interlayer
110, 606, 704: functional layer
111: radar unit
112: connection lines
113: de-coated regions
110: functional layer
114: antenna

1. An automotive glazing comprising:
a first substrate of glass or polymer;
at least one functional layer having electromagnetic properties, wherein at least one de-coated region is defined on the at least one functional layer;
at least one antenna unit, wherein at least a portion of the antenna unit is aligned with the at least one de-coated region of the at least one functional layer; and
a radar unit connected to the at least one antenna unit.

2. An automotive glazing comprising:
a first substrate of glass or polymer;
at least one functional layer having electromagnetic properties, wherein at least a portion of the at least one functional layer is defined as an antenna unit; and
a radar unit connected to the antenna unit.

3. The automotive glazing as claimed in claim 1, wherein the at least one de-coated regions on the at least one functional layer is selectively designed or patterned and is selectively located across the glazing, such that the at least one de-coated region is adapted to facilitate antenna beam requirements.

4. The automotive glazing as claimed in claim 1, wherein the radar unit is partially or completely disposed in the glazing via a through-hole or cut-out on the glazing such that a cut-out region extends to one or all the substrates of the glazing.

5. The automotive glazing as claimed in claim 1, wherein the radar unit is mounted on the first substrates of the glazing by way of surface mounting on the first substrates of the glazing.

6. The automotive glazing as claimed in claim 1, wherein the at least one functional layer of the glazing is configured to function as multi-functional units capable of radio frequency transmission, radio frequency signal generation, reflecting infrared rays and for heating.

7. The automotive glazing as claimed in claim 1, wherein the at least one functional layer is configured to function as an emitter, reflector, a director, or a ground plane or a combination thereof.

8. The automotive glazing as claimed in claim 1, wherein the glazing further comprising:
a second substrate of glass or polymer; and
one or more interlayers sandwiched between the first substrate and the second substrate.

9. The automotive glazing as claimed in claim 8, wherein the one or more interlayers are adapted to function as di-electric layer or insulating layer.

10. The automotive glazing as claimed in claim 1, wherein the radar unit is a multiple-input multiple-output (MIMO) radar configured to communicate with an array of transmitting antennas and receiving antennas.

11. The automotive glazing as claimed in claim 1, wherein the radar unit is integrated within an encapsulation of the glazing.

12. The automotive glazing as claimed in claim 8, further comprising an emissive film for tint matching and further for display functionality.

13. The automotive glazing as claimed in claim 1, wherein the at least one de-coated regions is filled with non-conductive coatings adapted to reflect infrared rays thereby controlling the thermal properties inside a cabin of the vehicle.

14. The automotive glazing as claimed in claim 1, wherein the functional layer is coated in the form of thin line graph like structures, grid like-structures or teeth-like structures, or a combination of any of these.

15. The automotive glazing as claimed in claim 1, wherein the radar units of the glazing in a vehicle is adapted to be connected to a single data acquisition unit and the radar units coupled with the at least one antenna units is adapted to be configured to a control unit.

16. A system for radio detection and ranging in a vehicle, comprising:
a glazing, wherein the glazing comprises:
at least a first substrate of glass or polymer;
at least one functional layer having electromagnetic properties;
at least one antenna unit; and
a radar unit connected to the at least one antenna unit; and
a control unit operably coupled with the radar unit and the at least one antenna units for detection of objects for at least being applied for applications comprising blind spot detection, forward and rear collision, parking assistance, lane change and adaptive cruise control, wherein the location of said at least one antenna units in the glazing is dependent on one of said applications.

17. The system as claimed in claim 16, wherein the radar unit is operably connected to a data acquisition unit.

18. The system as claimed in claim 16, wherein the radar unit along with the at least one antenna unit is capable of operating in short, medium and long range frequencies and the design of the de-coated structure is configured to provide the relevant radio frequency transmission for other frequencies including 5G, Wireless Fidelity (WiFi), ultrahigh frequency (UHF), Long-Term Evolution (LTE), global positioning system (GPS).
